(19) United States
(12) Patent Application Publication
(10) Pub. No.: US 2022/0309063 A1
(43) Pub. Date: Sep. 29, 2022

(54) QUERY REWRITE USING MATERIALIZED VIEWS WITH LOGICAL PARTITION CHANGE TRACKING

(71) Applicant: Oracle International Corporation, Redwood Shores, CA (US)

(72) Inventors: Binglu Du, Westford, MA (US); Murali Thiyagarajah, Concorn, NH (US); Praveen Tupati Jaganath Kumar, Nashua, NH (US); Randall Bello, Austin, TX (US)

(21) Appl. No.: 17/214,298

(22) Filed: Mar. 26, 2021

(51) Int. Cl. G06F 16/2453; G06F 16/2455

(52) U.S. Cl. CPC G06F 16/24539; G06F 16/24557; G06F 16/24537

(57) ABSTRACT

Using Logical Partition Change Tracking (LPCT), a database system is able track the staleness of a materialized view at the level of logical partitions of a base database object, in addition to or instead of tracking the staleness of a materialized view at the level of physical partitions of the base database object. When the base database object is logically partitioned, it is possible using LPCT for the system to identify the records of the materialized view that correspond to changed logical partitions of the base database object. The records of the materialized view corresponding to the changed logical partitions become stale while other records of the materialized view corresponding to unchanged logical partitions remain fresh. The ability to identify which records of a materialized view are fresh and which are stale at the level of logical partitions of the base database object allows the system to rewrite user queries to use those records of the materialized view that are fresh.

### TECHNICAL FIELD

The present disclosure relates to computer database management systems. More specifically, the present disclosure relates to computer-implemented techniques for query rewrite using materialized views with logical partition change tracking.

### BACKGROUND

In database management systems, materialized views are a powerful mechanism for optimizing the processing of queries. A query is defined as a logical expression over database data and the data relationships set forth in the database, and results in the identification of a subset of the database data.

The execution of a request for information from a database management system (DBMS), or just “database system,” is issued by a client computer system as one or more Structured Query Language (SQL) queries or the like for retrieving particular data from database objects at a server computer system. A database object is any defined object in the database that is used to store or reference data. Examples of database objects include tables, indexes, views, physical partitions, and materialized views.

A materialized view is a database object that contains the results of a query. Instantiation of a materialized view is accomplished by executing the query against database objects and storing the result set of the query execution in another database object. The database object(s) referred to in the query from which the result set is derived are referred to as the “base” database object(s) of the materialized view and those database object(s) are said to be “referenced in” the materialized view by way of the query. The query that is executed against the base data object(s) to instantiate a materialized view is referred to as the “instantiation” query of the materialized view.

Consider, as a simple example, the following SQL query that provides an aggregation of the dollar amount sold every month:

```
SELECT times.calendar_month_desc,
    SUM(sales.amount_sold)
FROM sales,
  times
WHERE sales.time_id = time_id
GROUP BY times.calendar_month_desc;
```

If the above query is used to instantiate a materialized view, then the sales and times tables are the “base” database objects of the materialized view and those tables are “referenced in” the materialized view by way of the instantiation query.

When a database system receives a user query that asks for data from one or more base database objects of a materialized view, the database system determines if the user query can be rewritten to be executed against the materialized view and thereby provide an answer to the user query more quickly.

Returning the above example, consider, as a simple example, the following user query that asks for the sum of the amount sold for each calendar month:

```
SELECT times.calendar_month_desc,
    SUM(sales.amount_sold)
FROM sales,
  times
WHERE sales.time_id = time_id
GROUP BY times.calendar_month_desc;
```

Without a materialized view and query rewrite available, the database system needs to perform computationally expensive operations that the database system would not need to perform if a materialized view and query rewrite were available to answer the user query. In the current example user query, without the previous example materialized view and query rewrite available, the database system needs to compute the sum of the amount sold from records of the “sales” database object. Depending on the size of the “sales” database object, this might involve reading many millions of records of the “sales” database object with corresponding significant computer storage media (e.g., disk) access. The join in the user query also significantly increases the query response time as the join needs to be computed on many millions of records.

In contrast, with the previous example materialized view and query rewrite functionality, the database system can rewrite the example user query to the following rewritten query to be executed against the materialized view:

SELECT calendar_month, dollars
FROM cal_month_sales_mv;

Here, “cal_month_sales_mv” is the given name of the previous example materialized view and “calendar month” and “dollars” are the given names of fields of the materialized view. Since the materialized view contains the results of the previous example instantiation query, the materialized view may contain only a few dozen records. Further, the rewritten query does not contain a join. Consequently, the database system can answer the previous example user query essentially instantaneously by executing the rewritten query against the materialized view and returning the result of the rewritten query as an answer to the user query. Clearly, materialized views are a powerful mechanism for optimizing the processing of queries.

A difference between a non-materialized view and a materialized view is that a materialized view may be instantiated once for many accesses while a view typically is instantiated for each access. This means that a materialized view typically requires computer storage media space to durably store the materialized view even when the materialized view is not being accessed. At the same time, the materialized view allows rewritten queries against the materialized view to be processed faster because the materialized view may not need to be instantiated for each rewritten query execution.

Since materialized views may not be instantiated for each rewritten query execution, a materialized view can become “stale” with respect to the base database object(s) referenced in the materialized view. In particular, changes to the base database objects referenced in a materialized view that occur after the materialized view is instantiated place the materialized view in a stale state because the result set of the materialized view does not reflect the after-instantiation updates to the base database objects.

In the case of a relational database system, changes to the base database object(s) can occur, for example, as the result of data manipulation language (DML) statement executions against the base database object(s). Such DML statements may include SQL LOAD, INSERT, UPDATE, DELETE, or other SQL DML statements that change or modify database data in the base database objects. When a materialized view becomes stale, the instantiation query of the materialized view can be re-executed against the base database objects to completely re-instantiate the materialized view. In other words, the materialized view can be completely “refreshed.” In some cases, the materialized view can be “incrementally” refreshed to incorporate changes to the base database object(s) without having to completely refresh the materialized view.

When a materialized view is not stale, a database system can rewrite a user query and execute the rewritten query against the materialized view. However, if a materialized view becomes stale, then the database system may not be able to rewrite the user query to execute against the materialized view depending on whether the user query can tolerate stale data or instead requires fresh data. If the database system is unable to rewrite the user query to execute against the materialized view, then the database system cannot leverage the efficiencies provided by the materialized view to answer the user query. Given the substantial query execution efficiencies provided by materialized views, it is typically desirable when answering a user query for the database management system when possible to retrieve data from a materialized view rather than retrieving the data from the underlying base table(s).

The techniques disclosed herein address this and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The General Overview section of the Detailed Description below provides a useful overview of the techniques for query rewrite using materialized views with logical partition change tracking.

### BRIEF DESCRIPTION OF THE DRAWINGS

The techniques are illustrated by way of example, and not by way of limitation, in the figures of the accompanying drawings and in which like reference numerals refer to similar elements and in which:

FIG. 1 depicts an example Data Definition Language (DDL) statement for creating a logical partitioning of a database object.

FIG. 2 depicts an example of logically partitioning a database object.

FIG. 3 depicts an example of database metadata defining a logical partitioning of a database object.

FIG. 4 depicts an example DDL statement for creating a logical partition change tracking (LPCT)-eligible materialized view.

FIG. 5 depicts an example of LPCT metadata.

FIG. 6 is a flowchart of a process for query rewrite using materialized views with LPCT.

FIG. 7 is a block diagram of an example basic computing device that may be used in an implementation of the techniques.

FIG. 8 is a block diagram of an example basic software system that may be employed for controlling the operation of the basic computing device of FIG. 7.

### DETAILED DESCRIPTION

In the following description, for the purposes of explanation, numerous specific details are set forth in order to provide a thorough understanding of the techniques. It will be apparent, however, that the techniques may be practiced without these specific details. In other instances, well-known structures and devices are shown in block diagram form to avoid unnecessarily obscuring the techniques.

### General Overview

One way to increase the probability that a user query can be rewritten to execute against a materialized view is for the database management system to track the staleness of the materialized view at a finer level of granularity such that the system can determine which portions of materialized view are stale and which are fresh. Physical Partition Change Tracking (PPCT) is one such way of tracking the staleness of a materialized view at a finer level of granularity. PPCT allows a database system to rewrite a user query to execute against a partially stale materialized view. With PPCT, changes to a physically partitioned base database object are tracked on a per-physical partition basis as opposed to only on the entire base database object. By doing so, the database system can determine which partitions of the base database object are stale and which partitions are still fresh. The database system can then rewrite a user query that asks for data in a fresh partition of the base database object to retrieve the data from the corresponding portion of the materialized view even if other partitions of the base database object are stale.

A drawback of PPCT based query rewrite is that physical partitioning of the base database object is required. With physical partitioning, the data of the base database object is physically divided over multiple distinct data storage structures (e.g., data files, segments, or extents). Due to the physical nature of physical partitioning, it is often undesirable or impractical to physically partition or physically re-partition a base database object after the base database object has been created and populated with data. In particular, such physical partitioning or physical re-partitioning can require movement of the data between physical data storage structures. For large amounts of data or where moving the data requires making the base database object(s) temporarily unavailable to user queries, such movement is undesirable or impractical.

The techniques disclosed herein address this and other issues.

In general, the techniques allow a database system to track the staleness of a materialized view at the level of logical partitions of the base database object(s), in addition to or instead of tracking the staleness of a materialized view at the level of physical partitions of the base database object(s). The ability to identify which records of a materialized view are affected by a certain logical partition of a base database object, is referred to herein as “Logical Partition Change Tracking” (LPCT). When one or more of the base database objects are logically partitioned, it is possible using LPCT for the system to identify the records of the materialized view that correspond to changed logical partitions(s) of the base database object(s). The records of the materialized view corresponding to the changed logical partition(s) become stale while other records of the materialized view corresponding to unchanged logical partition(s) remain fresh. The ability to identify which records of a materialized view are fresh and which are stale at the level of logical partitions of the base database object(s) allows the system to rewrite user queries to use those records of the materialized view that are fresh.

There are other benefits of query rewrite using materialized views with LPCT. For one, a base database object can more easily be logically partitioned after the base database object has been created and populated with data compared to physical partitioning because no data movement is required by logical partitioning. As a result, the query processing efficiencies of query rewrite using a partially stale materialized view can be realized after the base database object(s) are created and even if the base database object(s) were not originally physically partitioned at creation. For example, a user can decide to logically partition a base database object after a database application has been adding data (e.g., time-based sales data) to the base database object for some time (e.g., days, weeks, months, or years). After the base database object is logically partitioned, LPCT on the base database object enables query rewrite using a partially stale materialized view.

While a user may decide to logically partition a base database object, the database management system itself may automatically determine that certain user queries would benefit from a logical partitioning of a base database object. For example, the database management system may have autonomous functionality that automatically analyzes user query workloads to automatically determine user queries that would benefit from query rewrite using a materialized view. The system may then automatically create the materialized view for use by future user queries. In addition, the autonomous database management system may automatically determine that query rewrite using the automatically created materialized view would further benefit from logical partitioning of a base database object of the materialized view. The database management system may then automatically logically partition the base database object. Using techniques disclosed herein, the system can then rewrite user queries to use the materialized view even if the materialized view is partially stale.

Techniques for query rewrite using materialized views with logical partition change tracking, as well as the above and other benefits thereof, are described in greater detail below.

### Logical Partitioning

As indicated, if a materialized view is only deemed completely stale or completely fresh by the database management system, then the materialized view cannot be used for query rewrite when one or more of the base database objects are changed. PPCT-based query rewrite allows query rewrite on partially stale materialized views but requires the base database objects to be physically partitioned. This is problematic if a base database object already contains database data when a decision is made to physically partition the database object. In this case, computationally expensive data movement may be required to accomplish the physical partitioning. Another problem can arise if the physical partitioning key used for physical partitioning of a base database object is not one involved in a materialized view built based on the base database object. In this case, user queries that do not involve the physical partitioning key cannot take advantage of PPCT-based query rewrite against the materialized view.

LPCT-based query rewrite, on the other hand, does not require the base database objects to be physically partitioned (but does not prohibit it). A logical partition of a base database object is logically defined by a logical partitioning key and logical partition method. LPCT records data changes to each logical partition of a base database object in database metadata associated with the base database object. By doing so, the database management system can identify fresh parts of a materialized view that can be used for query rewrite.

It should be noted that a base database object of a materialized view can be both logically partitioned and physically partitioned. In this case, the logical partitioning key can be different than the physical partitioning key. As a result, user queries can be rewritten to execute against a partially stale materialized view based on LPCT even if the user queries cannot be rewritten based on PPCT.

A database object can be logically partitioned in response to a user command that specifies logical partitioning criteria. Alternatively, the database management system may automatically determine to logically partition the base database object in response to detecting a condition indicating that the base database object should be logically partitioned. An example of such a condition is the system detecting a query workload pattern indicating that user queries that ask for data from the base database object would obtain a query rewrite benefit from a materialized view that references the base database object and would also obtain a query rewrite benefit from a logical partitioning of the base database object that allows the user queries to be rewritten to execute against fresh portions of the materialized view corresponding to fresh logical partitions of the base database object. In this case, the database management system may automatically create the materialized view and automatically logically partition the base database object.

### Creating Logical Partitions

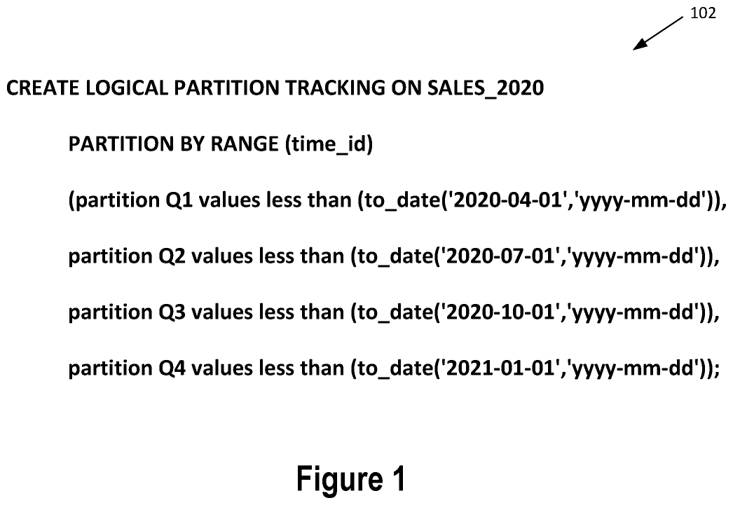

FIG. 1 depicts example Data Definition Language (DDL) statement 102 for creating a logical partitioning of a “SALES_2020” database object. DDL is a syntax for creating and modifying database objects such as tables, indices, materialized views, physical partitions, and logical partitions. DDL statements are often supported by relational database management systems that also support SQL.

At the time logical partitions of a database object are created by the system, the database object may not contain any records. However, the database object may contain many records at the time (e.g., tens, hundreds, thousand, or millions of records). For example, when statement 102 is submitted to the system, the “SALES_2020” database object may not contain any records or may contain millions of records reflecting millions of sales transactions during the year 2020.

Another name for a record is a “row” and the terms may be used interchangeably throughout this description. A record may be divided into one or more fields, which are sometimes referred to as “columns.” Each field contains an “attribute” of the record. In the example of FIG. 1, records of the “SALES_2020” database object each have at least a column named “time_id,” possibly among other columns. The “time_id” attribute of a record in the “SALES_2020” database object specifies a calendar date.

A DDL statement for logically partitioning a database object such as statement 102 can be issued to the system by a database administrator or other user of the system. Instead, if the system is an autonomous database management system, then the system might automatically determine to logically partition a database object in the same way as specified in a DLL statement. Thus, the discussion following pertaining to how the system processes example statement 102 applies equally to both the situation where statement 102 is issued to the system by a user or computing process and the situation where the system automatically determines to logically partition the database object in the same way as specified by statement 102.

When the system creates logical partitions of a database object either in response to submission of a DDL statement for creating the logical partitions or automatically as part of autonomous operation, the system creates and stores metadata in the database that logically divides the database object into logical partitions based on a logical partitioning key, a logical partitioning method, and logical partitioning criteria. The logical partitioning key, method, and criteria can be specified in the DDL statement or determined automatically by the system based on analyzing historical query workloads.

In the example of FIG. 1, statement 102 specifies the logical partitioning key, the logical partitioning method, and the logical partitioning criteria. In particular, statement 102 logically divides the “SALES_2020” database object into four logical partitions based on ranges on the “time_id” column corresponding to sales quarters of year 2020. The “time_id” column is the partitioning key. The logical partitioning method is “range” partitioning. And the logical partitioning criteria are the four date ranges that define the four logical partitions. Specifically, logical partition “Q1” includes the records of the “SALES_2020” database object having a date value for the “time_id” column less than a date value representing Apr. 1, 2020. Logical partition “Q2” includes the records of the “SALES_2020” database object having a date value for the “time_id” column equal to or greater than the date value representing Apr. 1, 2020 but less than a date value representing Jul. 1, 2020. Logical partition “Q3” includes the records of the “SALES_2020” database object having a date value for the “time_id” column equal to or greater than the date value representing Jul. 1, 2020 but less than a date value representing Oct. 1, 2020. Logical partition “Q4” includes the records of the “SALES_2020” database object having a date value for “time_id” column equal to or greater than the date value representing Oct. 1, 2020 but less than a date value representing Jan. 1, 2021. In this way, each record representing a sale of the “SALES_2020” database object is assigned to one logical partition of the four logical partitions corresponding to the sales quarter of year 2020 in which the sale occurred.

Logical partitioning by ranges is one possible logical partitioning method for logically partitioning a database object. Range logical partitioning encompasses interval logical partitioning. Interval logical partitioning is an extension of range logical partitioning in which, beyond a point in time, logical partitions are defined by an interval. Interval logical partitions may be automatically created by the database system when data is inserted into a logical partition. Range or interval logical partitioning may be used to organize database data by time intervals on a column of a database object of data type DATE or the like.

Generally, when a database object is logically partitioned by range, then each logical partition of the database object logically contains records for which a value or a logical partitioning expression value lies within a given range of values. Logical partitioning ranges are typically contiguous and non-overlapping. Statement 102 is an example of logical partitioning by range. However, other logical partitioning methods are possible including logical partitioning by list. Generally, when a database object is logically partitioned by list, then each logical partition of the database object logically contains records for which a value or a logical partitioning expression value is on a given list of discrete values.

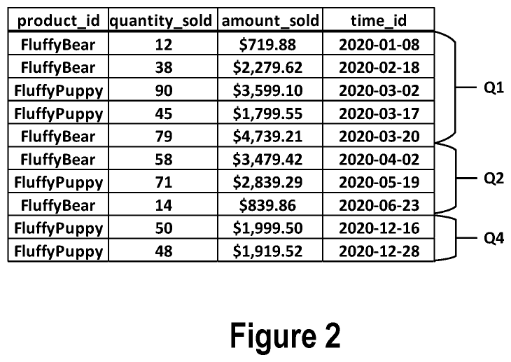

When a database object is logically partitioned, then a record of the database object logically belongs to one logical partition. FIG. 2 depicts an example of the “SALES_2020” database object that is logically partitioned according to the key, method, and criteria of statement 102 of FIG. 1, according to some embodiments of the present invention. In this example, the records of the “SALES_2020” database object happen to be ordered in increasing order of the logical partitioning key “time_id.” However, it is not a requirement that the records of a logically partitioned database object be sorted by the logical partitioning key. In this example, by the values in the “time_id” column, the first five records in the sorted order logically belong to the “Q1” logical partition, the next three records in the sorted order logically belong to the “Q2” logical partition, no records currently belong to the “Q3” partition, and the last two records belong to the “Q4” logical partition. The “SALES_2020” database object contains “product_id,” “amount sold,” and “quantity sold” columns in addition to the “time_id” column.

While in some embodiments the logical partitioning key is a column containing time-based values, the logical partitioning key is a column containing other types of values. For example, a logical partitioning key could be a categorical column such as, for example, the “product_id” column of “SALES_2020” database object where each value in the column is one in a closed set of values, a numerical column such as, for example, the “amount sold” column or the “quantity sold” column of the “SALES_2020” database object, or a text column such as, for example, a “last name” column.

As mentioned, the database may store metadata defining the logical partitions of a database object. For a database object logically partitioned by range, then the metadata may include an identifier for each logical partition and an indication of ranges of values of the logical partitioning key. The logical partition to which a record of the logically partitioned database object logically belongs can be determined by which range of values the value of the logical partitioning key of the record lies within.

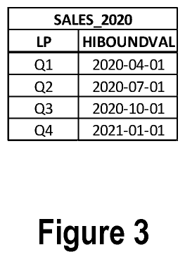

For example, FIG. 3 depicts an example of database metadata defining the logical partitioning of the “SALES_2020” database object discussed above. In the example of FIG. 3, associated with an identifier of a logical partition (“LP”) is a high bound value (“HIBOUNDVAL”) on the logical partitioning key that indicates a range of values of the logical partitioning key that lie within the logical partition. The logical partition to which a record of the “SALES_2020” database object belongs can be determined by which range of values the value of the “time id” key of the record lies within. For example, all records of the “SALES_2020” where the value of the “time_id” column is less than the date value Oct. 1, 2020 and greater than or equal to the date value Jul. 1, 2020 belong to the “Q3” logical partition.

Other approaches to indicate ranges of values on the logical partitioning key in database metadata may be used. The invention is not limited to the high bound value approach of the example. For example, database metadata may define both a lower bound value and a higher bound value for each logical partition or just a lower bound value instead of just a high bound value. Further, database metadata may define a Boolean expression that may be applied to the value of the logical partitioning key of a record to determine whether the record belongs to the corresponding logical partition.

For a database object logically partitioned by list, then the metadata may include an identifier for each logical partition, like in the range logical partitioning case, but instead of indicating ranges of values of the logical partitioning key, the database metadata indicates lists of discrete values of the logical portioning key.

In the example above, four logical partitions of the “SALES_2020” database object are created. However, a database object can be logically partitioned into fewer than four logical partitions or more than four logical partitions according to the requirements of the particular implementation at hand including the characteristics and distribution of the values of the logical partitioning key and the historical or expected user queries that reference the logical partitioning key and the database object. For example, the “SALES_2020” database object is logically partitioned by sales quarter as many historical or expected user queries that ask for data from the “SALES_2020” database object may filter or aggregate the data by sales quarter.

It should be recognized from the above description that, in contrast to physical partitioning, creating a logical partition does not require creating new data storage structures (e.g., files, segments, or extents) in the database to contain data of the logically partitioned database object and does not require movement of data of the database object between data storage structures. Instead, creation of a logical partition involves merely creating and storing database metadata in the database that defines, indicates, or implies the logical partition where such metadata can encompass: an identifier of the database object logically partitioned, an identifier of the logical partition key of the database object, the logical partitioning method (e.g., range or list), and logical partitioning criteria for determining which records of the database object belong the logical partition.

### Creating Materialized Views

In addition to creating logical partitions of a database object, a materialized view that references the database object may be created. The materialized view may be created before or after the database object is logically partitioned. Thus, there is no requirement that the materialized view be created before a database object referenced in the materialized view is logically partitioned and no requirement that a database object referenced in a materialized view be logically partitioned before the materialized is created.

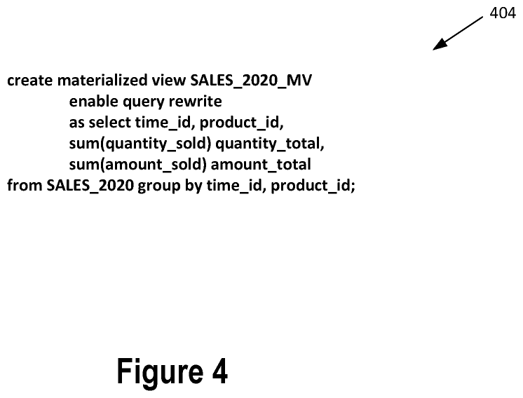

Like a logical partitioning of a database object, a materialized view can be created by the database system in response to submission of a DDL statement or automatically as part of autonomous operation. FIG. 4 depicts example DDL statement 404 for creating a materialized view that references the SALES_2020 database object and with query rewrite enabled. The instantiation query of the materialized view computes the sum of the values in the “quantity sold” column and the sum of the values in the “amount sold” column of records having the same values of the “time_id” column and the “product_id” column. The resulting materialized view can have a record for each distinct “time_id” and “product_id” value pair of the SALES_2020 database object with a “quantity_total” column containing a value that is the total number of units sold of the corresponding product for the corresponding time_id and with an “amount total” column containing a value that is the total amount sold of the corresponding product for the corresponding time_id.

By having the following characteristics, a materialized view supports logical partition change tracking:
The materialized view references a logically partitioned base database object,
The base database object is logically partitioned by range or by list,
The materialized view contains the logical partitioning key as one of the columns of the materialized view, and
If a GROUP BY clause is used in the instantiation query of the materialized view, then the logical partition key is contained in the GROUP BY clause.

The above characteristics are sufficient to support logical partition change tracking, but not necessary. Thus, materialized views with other sets of characteristics may support logical partition change tracking.

The materialized view created by DDL statement 404 supports logical partition change tracking. The materialized view “SALES_2020 MV” references the logically partitioned “SALES_2020” database object. The “SALES_2020” database object is logically partitioned by range. The “SALES_2020 MV” materialized view contains the “time_id” logical partitioning key as a column. The “GROUP BY” clause of the instantiation query of the “SALES_2020 MV” materialized view contains the “time_id” logical partitioning key. Thus, the “SALES_2020 MV” materialized view is LPCT eligible (i.e., supports LPCT).

As part of an autonomous database management system, the database system may automatically create (instantiate) a materialized view such as, for example, the “SALES_2020 MV” materialized view. To do this, the system may analyze a workload of a set of user queries and automatically create a materialized view capable of rewriting a substantial number of user queries. The system may select the materialized view based on cost and verify the selected materialized view in the database system. The database system may encompass an automated process or component that automatically generates, selects, and verifies automatically created materialized views. As such, some or all of the materialized views of the system may be materialized views automatically created by the system. While all materialized views of the system can be automatically created by the system, some or all materialized views of the system can be created by the system in response to a database administrator or other user or a computing process issuing a DDL statement to the system such as, for example, statement 404. Thus, materialized views of the system can be all automatically created, all created based on issuance of DDL statements to the system, or a mix of automatically created and created in response to issuance of DDL statements.

Process(es) of the system that automatically create materialized views may run autonomously and continually in system. For example, the process(es) may run as low-profile tasks that are limited in the amount of database system computing resources (e.g., CPU resources) they can consume so as not to starve potentially more critical tasks (e.g., query processing process(es)) of system of computing resources.

The database system may be configured to analyze a workload of user queries to determine and create materialized views that would significantly improve user query execution performance. In operation, the database system may process and classify the workload user queries. Like user queries may be grouped together by query patterns such as, for example, group by, selections, orderings, etc. The database system may then form materialized view recommendations based on the classifications. Each recommendation may include one or more recommended materialized views. Recommended materialized views may be verified. A recommended materialized view may not be published by the database system to a set of active materialized views until the database system confirms the value of the materialized view. Verification of a recommended materialized view before publishing may involve executing workload user queries to verify that a performance improvement is provided by the recommended materialized view.

### Query Rewrite

The database system has a query rewrite module for rewriting user queries originally intended for execution against base database objects to rewritten queries that are executed at least in part against materialized views. The results of the rewritten queries are returned by system as query results to the submitted user queries. The query rewrite module may rewrite user queries to rewritten queries to speed up query processing by the system. That is, the query rewrite module may rewrite a user query to a corresponding rewritten query if the query rewrite module can determine that rewriting the user query and executing the rewritten query instead of executing the user query will result in improved query processing performance (e.g., reduced query processing latency as defined roughly by a time period that starts when the user query arrives at the system and ends when the system produces the query results).

The query rewrite module may rewrite a user query submitted from a client computing device in a way that is transparent to the client computing device. That is, aside from the query result being obtained more quickly from the system, the transformation of the user query to the rewritten query and the execution of the rewritten query by the query rewrite module may be transparent to the client computing device.

In operation, the query rewrite module may subject a user query to several checks to determine whether it is a candidate for query rewrite. If the user query fails any of the checks, then the user query is executed against one or more base database objects rather than a materialized view. Failure to rewrite a user query can be costly in terms of query processing latency and computing resources consumed.

The query rewrite module may use different methods to recognize when to rewrite a user query in terms of a materialized view. One possible method is based on matching the text of the user query with the text of the instantiation query of the materialized view according to a text matching algorithm. If text matching fails, the query rewrite module may use a more general matching algorithm in which the query rewrite module compares joins, selections, fields, grouping fields, and aggregation functions between the user query and the instantiation query materialized view.

The query rewrite module can perform full or partial text matching between the user query and the instantiation query of the materialized view. If a full text match is made, the query rewrite module can rewrite the user query entirely in terms of the materialized view. However, if only a partial text match is made, then query rewrite module rewrites the user query where one or more of the base database objects referenced in the user query remain referenced in the rewritten query in addition to a reference to the materialized view. If the query rewrite module cannot make either a full or partial text match between the user query and the instantiation query of the materialized view, the query rewrite module may attempt to match the user query to the instantiation query according to the general matching algorithm.

The query rewrite module may rewrite a user query to a rewritten query with a delta join. There are two types of delta joins: a “user query” delta join and a “materialized view” delta join. A user query delta join is a join that appears in the user query but not in the instantiation query of the materialized view. Any number and type of user delta joins in a user query may be allowed and they may simply be retained when the user query is rewritten to reference the materialized view. Upon rewrite, the materialized view is joined to the appropriate tables in the user query delta. A materialized view delta join is a join that appears in the instantiation query of the materialized view but not in the user query. A materialized view delta join may be required to be a lossless and non-duplicating with respect to the result of common joins.

The query rewrite module may support query rewrite with logical partition change tracking. In this case, a base database object referenced in a materialized view may be logically partitioned into multiple logical partitions and the staleness of the materialized view is tracked on a per-logical partition basis rather than for the entire base database object. As a result, some records of the materialized view can be fresh (not stale) while others are stale. In particular, only the records of the materialized view derived from data in the changed logical partition(s) of the base database object need to be marked stale. Other records of the materialized view derived from unchanged logical partition(s) remain fresh. If a given user query only needs data from records of the materialized view that are fresh, then the query rewrite module can still rewrite the user query to execute against the materialized view even though some of the records of the materialized view are stale.

The query rewrite module may support rewrite hints. A rewrite hint in a user query tells the query rewrite module to rewrite the user query to execute against a materialized view even if the query rewrite module determines the cost of rewriting and executing the rewritten query outweighs the benefit of doing so. A no rewrite hint in a user query tells the query rewrite module to not rewrite the user query and to execute the user query against base database object(s) even if the query rewrite module determines there would be a cost benefit in rewriting the user query and executing the rewritten user query against a materialized view.

A query rewrite opportunity may be missed with respect to a materialized view if the materialized view is stale, or is stale in relevant part (e.g., for logical partition tracked materialized views). For example, the query rewrite module may make a preliminary determination that a given user query would benefit from or is a candidate for rewrite against a particular materialized view. However, if the data the user query requests from the particular materialized view is stale and the user query cannot tolerate staleness (e.g., as indicated by a rewrite hint in the user query), then an opportunity to rewrite the user query to execute the particular materialized view has been missed. In that case, if the user query cannot be rewritten to be executed against another materialized view, then the user query may be executed against base database object(s) without rewriting the user query to execute against a materialized view.

### Logical Partition Change Tracking

With logical partition change tracking, if a change is made to a record of a logically partitioned database object, then just the logical partition containing the record is marked stale, while other logical partitions that are fresh can remain marked fresh. To track which logical partitions are stale and which are fresh, additional “LPCT” metadata may be stored and maintained in the database. The LPCT metadata may be associated with a materialized view that references a logically partitioned database object. LPCT metadata may extend or reference the metadata defining, specifying, or implying the logical partitions of the base database object. Alternatively, the LPCT metadata may repeat (duplicate) some or all of the metadata defining, specifying, or implying the logical partitions of the base database object in the LPCT metadata. In either case, the LPCT metadata may define, specify, or imply all the following information about the logically partitioned database object referenced in the materialized view:
An identifier of the logically partitioned base database object,
An identifier of the materialized view,
An identifier of the logical partition key of the base database object,
A respective identifier for each of one or more logical partitions of the base database object,
A respective freshness indicator (e.g., “stale”/“fresh”; I/O; “yes”/“no”, or other

Boolean value) for each of the one or more logical partitions, and Respective logical partitioning criteria for each of the one or more logical partitions.

If the base database object is referenced in multiple materialized views by the same logical partitioning key, then the above LPCT-metadata except for the identifier of the materialized view can be shared among the multiple materialized views. This is because the logical partitions, the logical partitioning key, the logical partitioning criteria, and the freshness state will be same for all the multiple materialized views.

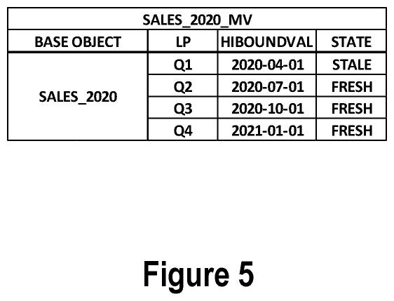

FIG. 5 depicts example LPCT metadata for the “SALES_2020 MV” materialized view that references the “SALES_2020” base database object. For each logical partition of the “SALES_2020” base database object, a current freshness state is stored in association with the identifier of the logical partition. In the current example, logical partition “Q1” is currently stale while logical partitions “Q2,” “Q3,” and “Q4” are currently fresh. The logical partitioning criteria for each logical partition as reflected in the “HIBOUNDVAL” column is included in the LPCT metadata. The logical partitioning is included so that that the system can determine whether a user query asking for data from the SALES_2020 database object that contains a filter predicate on the logical partitioning key (e.g., “time_id”) is only asking for data that lies within fresh logical partitions. If so, that the system may be able to rewrite the user query to obtain the requested data from the SALES_2020 MV materialized view.

### Query Rewrite Using Materialized Views With LPCT

The following description presents method steps that may be implemented using processor-executable instructions, for directing operation of one or more computing devices under control of processor(s). The processor-executable instructions may be stored on a non-transitory storage media. The processor-executable instructions may also be stored as a set of downloadable processor-executable instructions, for example, for downloading and installation from an Internet location (e.g., a web site).

Query rewrite involves the database system transforming a user query expressed in terms of a base database object into a query accessing a materialized view that is defined on the base database object. The database system may do this transformation transparent to the user or database application and without requiring the user or database application to intervene and without requiring the user query to reference the materialized view. Because of this transparency, materialized views can be added or dropped to and from the database without invalidating user queries.

The database system may subject a user query to several checks for determining that the user query is a candidate for query rewrite. If the user query fails any of the checks, then the system may execute the user against the base database objects rather than the materialized view. This can be costly in terms of query processing latency and computing resources consumed (e.g., CPU).

In general, the database system may use two different methods to recognize when to rewrite a user query in terms of a materialized view. One method used by the system is based on matching text of the user query with text of the instantiation query of the materialized view. If that method fails, the database system uses the second method in which the system compares the joins, selections, data columns, grouping columns, and aggregation functions between the user query and the materialized view.

LPCT query rewrite enables the database system to accurately rewrite user queries using materialized views that are only partially fresh. To do so, the database system keeps track of which logical partitions in the base database objects have been changed. The database system then tracks which records in the materialized view originate from the affected logical partitions in the base database objects. The database system is then able to use those portions of the materialized view that are known to be fresh.

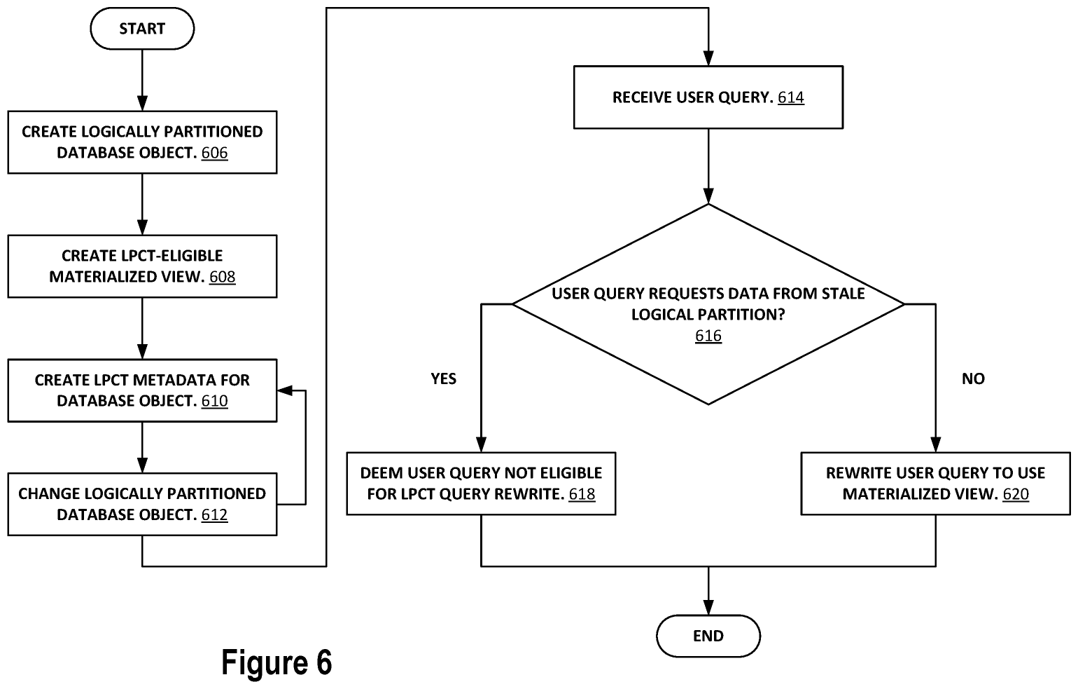

FIG. 6 is a flowchart of a method for query rewrite using a materialized view with LPCT.

At operation 606, a database object is logically partitioned by the database system. The do this, the database system stores database metadata in the database that defines the logical partitioning. The metadata indicates a column of the database object that is the logical partitioning key. The metadata also indicates the number of logical partitions and an identifier of each logical partition. The metadata indicates, for each logical partition, logical partitioning criteria for determining which records of the database object belong to which logical partitions. The database system may logically partition the database object by list, by range, or other suitable logical partitioning scheme. The database system may logically partition the database object in response to submission of a DDL statement to the system or automatically as part of autonomous operation. Statement 102 discussed above is an example of a DDL statement for logically partitioning a database object.

At operation 608, an LPCT-eligible materialized view is created in the database on the database object created at operation 606. An LPCT-eligible materialized view may refer to the logical partitioning key of the database object in the SELECT clause of the instantiation query of the materialized view. If the instantiation query has a GROUP BY clause, then an LPCT-eligible materialized view may also refer to the logical partitioning key in the GROUP BY clause of instantiation query. The SALES_2020 MV materialized view discussed above with respect to FIG. 4 is an example of an LPCT-eligible materialized view because the “time_id” column is referenced in both the SELECT clause and the GROUP BY clause.

At operation 610, logical partition change tracking is performed for the database object created at operation 606 and referenced in the LPCT-eligible materialized view created at operation 608. Logical partition change tracking can be performed in a continuous or periodic manner so long as LPCT is enabled for the database object.

LPCT 610 for the base database object involves the database system changing the freshness state in LPCT-metadata when a record of the database object belonging to a logical partition of the database object is updated, a record is added (inserted) to the database object that belongs to a logical partition, or a record that belongs a logical partition is removed (deleted) from the database object. Initially, after the LPCT-eligible materialized view is instantiated, all logical partitions of the base database object from which the materialized view is derived are fresh. Thereafter, changes 612 may occur to logical partitions of the base database object. The changes 612 may include updates, inserts, and deletes of records in the base database object. Such changes 612 cause the database system to mark the affected logical partition “stale” in LPCT-metadata. Operations 610 and 612 may repeat continuously or periodically while LPCT is enabled on the base database object.

For example, consider the following set of SQL statements that when submitted to the database system would affect all records in logical partitions “Q1” and “Q2” of the “SALES_2020” database object discussed above:

```
01: UPDATE SALES_2020 SET AMOUNT_SOLD =
      AMOUNT_SOLD * 0.9
02: WHERE TIME_ID < TO_DATE(‘2017-07-01’,
      ‘YYYY-MM-DD’);
03: COMMIT;
```

As a result of executing these SQL statements, the database system, as part of performing LPCT operation 610, would mark both logical partition “Q1” and logical partition “Q2” in LPCT-metadata as “stale,” assuming they were not already marked “stale.”

Thereafter, a user query received by the database system in operation 614 that references the base database object may be submitted to/received by the database system. If, at operation 616, the user query requests data from a logical partition of the base database object then marked “stale,” then, in operation 618, the database system may deem the user query ineligible for LPCT query rewrite. However, the database system may still rewrite the user query to use a materialized view based on a different query rewrite mechanism such as PPCT query rewrite if the base database object is physically partitioned in a compatible way, or the user query can tolerate the stale data. On the other hand, if, at operation 616, the user query requests data only from “fresh” logical partitions of the base database object, then the database system may rewrite 620 the user query to use the materialized view.

To determine whether the user query requests data from a “stale” logical partition of the base database object, the database system can compare a qualifying filter predicate expression on the logical partitioning key in the user query to the logical partitioning criteria in LPCT metadata. For example, assume the following user query is submitted for execution against the “SALES_2020” database object after the logical partitions “Q1” and “Q2” have been marked “stale” by the database system is response to execution of the example update statement above:

01: SELECT TIME_ID, PRODUCT_ID,
02: SUM(QUANTITY_SOLD) QUANTITY_TOTAL,
03: SUM(AMOUNT_SOLD) AMOUNT_TOTAL
04: FROM SALES_2020
05: WHERE TIME_ID > TO_DATE(‘2020-10-05’,
‘YYYY-MM-DD’)
06: GROUP BY TIME_ID, PRODUCT_ID;

Without LPCT, this user query would not be eligible for LPCT query rewrite against the “SALES_2020 MV” materialized view discussed above if the update to the “SALES_2020” database object caused the entire database object to be marked “stale” by the database system. However, with LPCT, since the user query requests data only from “fresh” logical partition “Q4” according to the filter predicate expression “WHERE TIME_ID>TO_DATE(‘2020-10-05’m ‘YYYY-MM-DD’)” in the user query and because the database system can determine from LPCT metadata that the “Q4” logical partition of the “SALES_2020” database object is currently fresh, then the database system can rewrite the user query to execute against the “SALES_2020_MV” materialized view. For example, the database system might rewrite the user query as follows to execute against the “SALES_2020_MV” materialized view:

01: SELECT SALES 2020_MV.TIME_ID,
02: SALES_2020_MV.PRODUCT_ID
03: SALES_2020_MV.QUANTITY_TOTAL,
04: SALES_2020_MV.AMOUNT_TOTAL
05: FROM SALES_2020_MV
06: WHERE SALES_2020_MV.TIME_ID >
TO_DATE(“2020-10-05”,“YYYY-MM-DD”)

Executing the above-rewritten query against the “SALES_2020 MV” materialized view may be more efficient than executing the user query against the “SALES_2020” base database object because the aggregations of the GROUP BY clause of the user query and the results of the SUM aggregation functions in the user query are pre-computed in the materialized view.

In conclusion, without LPCT, a materialized view that references a non-partitioned base database object is either entirely stale or entire fresh. If the materialized view is entirely stale, then the materialized view cannot be used for query rewrite even if a user query is asking for data only from a still fresh portion of the base database object.

However, with LPCT query rewrite, the staleness of a materialized view can be tracked at the granularity of logical partitions of a base database object referenced in the materialized view. Consequently, the database system can use for query rewrite data portions of the materialized view derived from the fresh logical partitions of the base database object even if other portions of the materialized view are derived from stale logical partitions of the base database object. As a result, utility of the materialized view by query workloads is increased, thereby improving the functioning of the database system.

### Database Management System Overview

The techniques may be used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, (e.g., Oracle Database 11 g). SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

A multi-node database management system is made up of interconnected nodes that share access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A client may issue a series of requests, such as requests for execution of queries, to a DBMS by establishing a database session. A database session comprises a particular connection established for a client to a database server through which the client may issue the series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e., can be created or terminated by the database server) and perform various database server functions. Database processes include processes running within a database session established for a client.

A database process is a unit of execution. A database process can be an computer system process or thread or a user defined execution context such as a user thread or fiber. Database processes may also include “database server system” processes which provide services and/or perform functions on behalf of entire database server. Such database server system processes include listeners, garbage collectors, log writers, and recovery processes.

A database dictionary may comprise multiple data structures that store database metadata. A database dictionary may for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the column names and datatypes of the columns, and one or more files or portions thereof that store data for the table. Metadata in the database dictionary defining a procedure may specify a name of the procedure, the procedure's arguments and the return datatype and the datatypes of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user defined function implemented in a JAVA class may be defined in part by the database dictionary by specifying the name of the users defined function and by specifying a reference to a file containing the source code of the Java class (i.e., java file) and the compiled version of the class (i.e., class file).

Query optimization generates one or more different candidate execution plans for a query, which are evaluated by the query optimizer to determine which execution plan should be used to compute the query.

Execution plans may be represented by a graph of interlinked nodes, referred to herein as operators or row sources, that each corresponds to a step of an execution plan, referred to herein as an execution plan operation. The hierarchy of the graphs (i.e., directed tree) represents the order in which the execution plan operations are performed and how data flows between each of the execution plan operations. An execution plan operator generates a set of rows (which may be referred to as a table) as output and execution plan operations include, for example, a table scan, an index scan, sort-merge join, nested-loop join, filter, and importantly, a full outer join.

A query optimizer may optimize a query by transforming the query. In general, transforming a query involves rewriting a query into another semantically equivalent query that should produce the same result and that can potentially be executed more efficiently, i.e., one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Cloud Computing

The techniques may be implemented in a “cloud computing” environment. The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (e.g., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (e.g., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

### Basic Computing Device

The techniques may be implemented by at least one computing device. If by more than one computing device, the techniques may be implemented in whole or in part using a combination of computing devices that are coupled together using a network, such as a packet data network. A computing device used in an implementation of the techniques may be hard-wired to perform some or all of the techniques, or may include digital electronic devices such as at least one application-specific integrated circuit (ASIC) or field programmable gate array (FPGA) that is persistently programmed to perform some or all of the techniques, or may include at least one general purpose hardware processor programmed to perform some or all of the techniques pursuant to program instructions in firmware, memory, other storage, or a combination. A computing device used in an implementation of the techniques may also combine custom hard-wired logic, ASICs, or FPGAs with custom programming to accomplish some or all of the techniques. A computing device used in an implementation of the techniques may be a server computing device, a workstation computing device, a personal computing device, a portable computing device, a handheld computing device, a mobile computing device or any other computing device that incorporates hard-wired or program logic to implement some or all of the techniques.

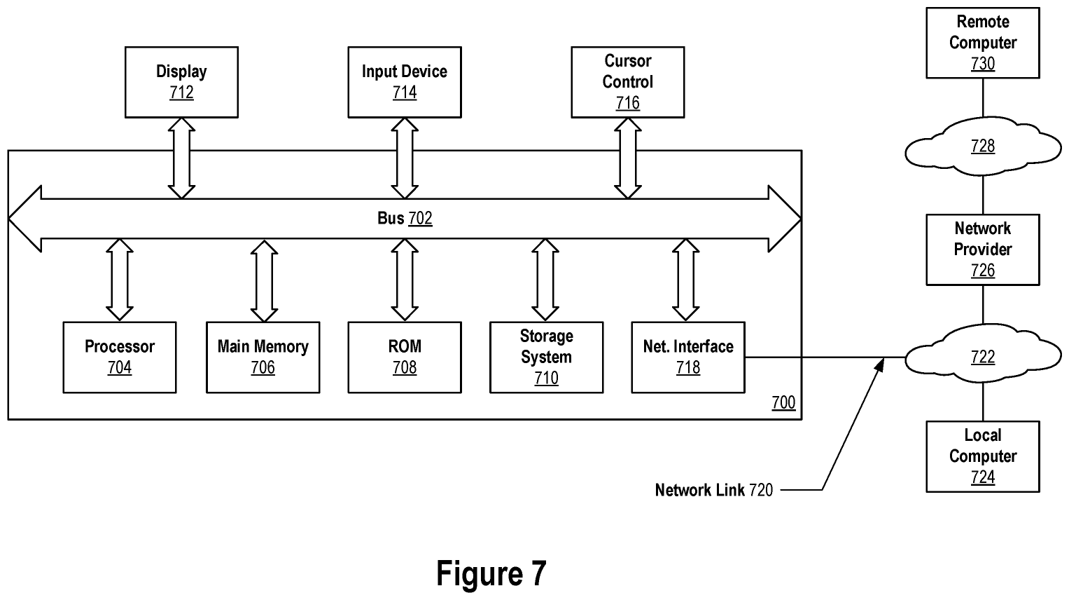

FIG. 7 is a block diagram of an example basic computing device that may be used in an implementation of the techniques. In the example of FIG. 7, computing device 700 and instructions for implementing some or all of the techniques in hardware, software, or a combination of hardware and software, are represented schematically, for example as boxes and circles, at the same level of detail that is commonly used by persons of ordinary skill in the art to which this disclosure pertains for communicating about computer architecture and computing device implementations.

Computing device 700 includes an input/output (I/O) subsystem 702 which may include a bus or other communication mechanism for communicating information or instructions between the components of the computing device 700 over electronic signal paths. The I/O subsystem 702 may include an I/O controller, a memory controller and at least one I/O port. The electronic signal paths are represented schematically in the drawings, for example as lines, unidirectional arrows or bidirectional arrows.

At least one hardware processor 704 is coupled to I/O subsystem 702 for processing information and instructions. Hardware processor 704 may include, for example, a general-purpose microprocessor or microcontroller or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computing device 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory storage media accessible to processor 704, can render computing device 700 into a special-purpose machine that is customized to perform the operations specified in the instructions.

Computing device 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM, and may be coupled to I/O subsystem 702 for storing information and instructions. Storage 710 is an example of a non-transitory computer-readable medium that may be used to store instructions and data which when executed by the processor 704 cause performing computer-implemented methods to execute some or all of the techniques.

The instructions in memory 706, ROM 708 or storage 710 may comprise one or more sets of instructions that are organized as modules, methods, objects, functions, routines or calls.

The instructions may be organized as one or more computer programs, operating system services or application programs including mobile apps. The instructions may comprise an operating system or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a database system using structured query language (SQL) or NoSQL, an object store, a graph database, a flat file system or other data storage.

Computing device 700 may be coupled via I/O subsystem 702 to at least one output device 712. Output device 712 may be a digital computer display. Examples of a display that may be used include a touch screen display or a light-emitting diode (LED) display or a liquid crystal display (LCD) or an e-paper display. Computing device 700 may include other types of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

An input device 714 may be coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, or various types of sensors such as force sensors, motion sensors, heat sensors, accelerometers, gyroscopes, and inertial measurement unit (IMU) sensors or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

Computing device 700 may comprise an internet of things (IoT) device or other computing appliance in which one or more of the output device 712, input device 714, and control device 716 are omitted. The input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computing device 700 is a mobile or portable computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computing device 700. Output device 712 may include hardware, software, firmware and interfaces for generating position reporting packets, notifications, pulse or heartbeat signals, or other recurring data transmissions that specify a position of the computing device 700, alone or in combination with other application-specific data, directed toward host 724 or server 730.

Computing device 700 may implement some or all of the techniques using customized hard-wired logic, at least one ASIC or FPGA, firmware or program instructions or logic which when loaded and used or executed in combination with computing device 700 causes or programs computing device 700 to operate as a special-purpose machine.

The techniques performed by computing device 700 may be performed in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform some or all of the techniques. Hard-wired circuitry may be used in place of or in combination with software instructions.

The term “storage media” as used herein refers to any non-transitory computer-readable media that store data or instructions that cause a machine to operation in a specific fashion. Such storage media may comprise non-volatile media or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computing device 700 can receive the data on the communication link and convert the data to be read by computing device 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computing device 700 also includes a communication interface 718 coupled to bus 702. Communication interface 718 provides a two-way data communication coupling to network link 720 that is directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server 730 broadly represents any computer, data center, virtual machine or virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls.

Computing device 700 and server 730 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, interne access applications, design and manufacturing applications, graphics applications, audio applications, software engineering applications, educational applications, games or miscellaneous applications. Server 730 may comprise a web application server that hosts a presentation layer, application layer and data storage layer such as a database system using structured query language (SQL) or NoSQL, an object store, a graph database, a flat file system or other data storage.

Computing device 700 can send messages and receive data and instructions, including program code, through a network, network link 720 and communication interface 718. In the Internet example, server 730 might transmit a requested code for an application program through Internet 728, ISP 726, local network 722 and communication interface 718. The received code may be executed by processor 704 as it is received, or stored in storage 710, or other non-volatile storage for later execution.

### Basic Software System

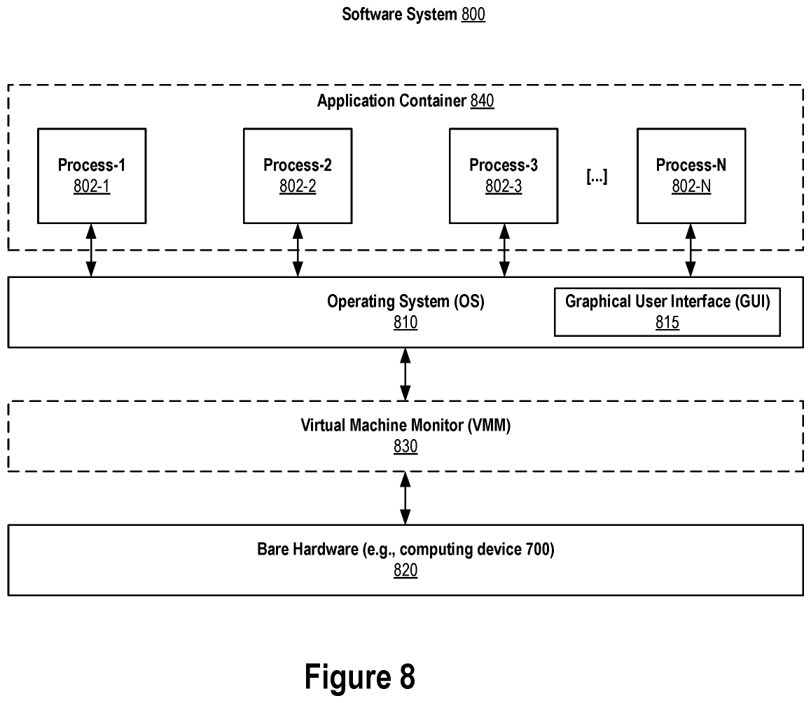

FIG. 8 is a block diagram of an example basic software system 800 that may be employed for controlling the operation of computing device 700 of FIG. 7. Software system 800 and its components, including their connections, relationships, and functions, is meant to be an example only, and not meant to limit implementations of the techniques. Other software systems suitable for implementing the techniques may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

OS 810 manages low-level aspects of computer operation, including managing execution of processes, represented as 802-1, 802-2, 802-3 . . . 802-N, memory allocation, file input and output (I/O) and device I/O. One or more application programs may be “loaded” (e.g., transferred from fixed storage 710 into memory 706) for execution as one or more processes by the system 800. The applications or other software intended for use on computing device 700 may also be stored as a set of downloadable computer-executable instructions, for example, for downloading and installation from an Internet location (e.g., a Web server, an app store or other online service).

The execution of application program instructions may implement a process (e.g., 802-2) in the form of an instance of a computer program that is being executed and consisting of program code and its current activity. Depending on the operating system (OS), a process (e.g., 802-3) may be made up of multiple threads of execution that execute instructions concurrently. In this context, a computer program is a passive collection of instructions, while a process (e.g., 802-1) may be the actual execution of those instructions. Several processes (e.g., 802-1 and 802-2) may be associated with the same program; for example, opening up several instances of the same program often means more than one process is being executed, or a program that initially launches as a single process may subsequently spawn (e.g., fork) additional processes.

OS 810 may implement multitasking to allow processes 802-1, 802-2, 802-3 . . . 802-N to share processor 704. While each processor 704 or core of the processor executes a single task at a time, computing device 700 may be programmed to implement multitasking to allow each processor to switch between tasks that are being executed without having to wait for each task to finish. Switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. For security and reliability, OS 810 may prevent direct communication between independent processes, providing strictly mediated and controlled inter-process communication functionality.

In some instances, processes 802-1, 802-2, 802-3 . . . 802-N and the application programs they implement may execute within application container 840. Application containers generally are a mode of operation of OS 810 in which OS 810 allows the existence of multiple isolated user space instances to run on OS 810. Application container 840 is an example of one such instance. The instances themselves are sometimes alternatively referred to as zones, virtual private servers, partitions, virtual environments, virtual kernels, or jails. Application containers provide a mechanism whereby finite hardware computing resources such as CPU time and storage media space can be allocated among the instances.

Software system 800 includes a graphical user interface (GUI) 815, for receiving user commands and data in a graphical (e.g., “point-and-click” or “touch gesture”) fashion. These inputs, in turn, may be acted upon by system 800 in accordance with instructions from operating system 810 or processes 802-1, 802-2, 802-3 . . . 802-N. GUI 815 also serves to display the results of operation from OS 810 and processes 802-1, 802-2, 802-3 . . . 802-N, whereupon the user may supply additional inputs or terminate the session (e.g., log off).

OS 810 can execute directly on bare hardware 820 (e.g., processor 704) of computing device 700. Alternatively, a hypervisor or virtual machine monitor (VMM) 830 may be interposed between bare hardware 820 and OS 810. In this configuration, VMM 830 acts as a software “cushion” or virtualization layer between OS 810 and bare hardware 820 of computing device 700.

VMM 830 instantiates and runs one or more virtual machine instances (“guest machines”). Each guest machine comprises a “guest” operating system, such as OS 810, and one or more applications, such as applications 802, designed to execute on the guest operating system. VMM 830 presents the guest operating systems with a virtual operating platform and manages the execution of the guest operating systems.

In some instances, VMM 830 may allow a guest operating system to run as if it is running on bare hardware 820 of computing device 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830. In these instances, the guest operating system is “aware” that it executes on a virtual machine monitor. In other words, VMM 830 may provide para-virtualization to a guest operating system in some instances.

### Other Aspects of the Disclosure

Unless the context clearly indicates otherwise, the term “or” is used in the foregoing specification and in the appended claims in its inclusive sense (and not in its exclusive sense) so that when used, for example, to connect a list of elements, the term “or” means one, some, or all of the elements in the list.

Unless the context clearly indicates otherwise, the terms “comprising,” “including,” “having,” “based on,” “encompassing,” and the like, are used in the foregoing specification and in the appended claims in an open-ended fashion, and do not exclude additional elements, features, acts, or operations.

Unless the context clearly indicates otherwise, conjunctive language such as the phrase “at least one of X, Y, and Z,” is to be understood to convey that an item, term, etc. may be either X, Y, or Z, or a combination thereof. Thus, such conjunctive language is not intended to require by default implication that at least one of X, at least one of Y and at least one of Z to each be present.

Unless the context clearly indicates otherwise, as used in the foregoing detailed description and in the appended claims, the singular forms “a,” “an,” and “the” are intended to include the plural forms as well.

Unless the context clearly indicates otherwise, in the foregoing detailed description and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

In the foregoing specification, the techniques have been described with reference to numerous specific details that may vary from implementation to implementation. The specification and drawings are, accordingly, to be regarded in an illustrative rather than a restrictive sense.

1. A method comprising:
logically partitioning a database object into a plurality of logical partitions based on a logical partitioning key;
creating a materialized view that references the logically partitioned database object and the logical partitioning key;
maintaining a respective freshness state for each of the plurality of logical partitions based on tracking changes to records of the database object;
receiving a user query;
determining that the user query asks for data only from one or more fresh logical partitions, of the plurality of logical partitions, based on the respective freshness state for each of the one or more fresh logical partitions; and
rewriting the user query to retrieve data from a portion of the materialized view instantiated based on records of the one or more fresh logical partitions of the database object;
wherein the method is performed by one or more computing devices.

2. The method of claim 1, further comprising:
determining that the user query asks for data only from the one or more fresh logical partitions based on a range of values for the logical partitioning key specified in the user query.

3. The method of claim 1, further comprising:
determining that the materialized view is eligible for logical partition change tracking-based query rewrite based on determining that an instantiation query of the materialized view references the logical partitioning key in a SELECT clause of the instantiation query.

4. The method of claim 1, further comprising:
determining that the materialized view is eligible for logical partition change tracking-based query rewrite based on determining that an instantiation query of the materialized view references the logical partitioning key in a SELECT clause of the instantiation query and in a GROUP BY clause of the instantiation query.

5. The method of claim 1, further comprising:
physically partitioning the database object into a plurality of physical partitions based on a physical partitioning key that is different than the logical partitioning key.

6. The method of claim 1, further comprising:
before logically partitioning the database object, populating the database object with data; and
wherein the database object is logically partitioned while the database object comprises data.

7. The method of claim 1, further comprising:
automatically logically partitioning the database object into the plurality of logical partitions as part of an autonomous database system operation.

8. The method of claim 1, further comprising:
automatically creating the materialized view as part of an autonomous database system operation.

9. The method of claim 1, further comprising:
logically partitioning the database object into the plurality of logical partitions based on receiving a command submitted to a database system by a user or a database application, the command specifying creation of the plurality of logical partitions and specifying the logical partitioning key.

10. The method of claim 1, further comprising:
creating the materialized view based on receiving a command submitted to a database system by a user or a database application, the command specifying creation of the materialized view.

11. One or more non-transitory storage media storing instructions which, when executed by one or more computing devices, cause the one or more computing devices to perform:
logically partitioning a database object into a plurality of logical partitions based on a logical partitioning key;
creating a materialized view that references the logically partitioned database object and the logical partitioning key;
maintaining a respective freshness state for each of the plurality of logical partitions based on tracking changes to records of the database object;
receiving a user query;
determining that the user query asks for data only from one or more fresh logical partitions, of the plurality of logical partitions, based on the respective freshness state for each of the one or more fresh logical partitions; and
rewriting the user query to retrieve data from a portion of the materialized view instantiated based on records of the one or more fresh logical partitions of the database object.

12. The one or more non-transitory storage media of claim 11, further comprising instructions which, when executed by the one or more computing devices, cause the one or more computing devices to perform:
determining that the user query asks for data only from the one or more fresh logical partitions based on a range of values for the logical partitioning key specified in the user query.

13. The one or more non-transitory storage media of claim 11, further comprising instructions which, when executed by the one or more computing devices, cause the one or more computing devices to perform:
determining that the materialized view is eligible for logical partition change tracking-based query rewrite based on determining that an instantiation query of the materialized view references the logical partitioning key in a SELECT clause of the instantiation query.

14. The one or more non-transitory storage media of claim 11, further comprising instructions which, when executed by the one or more computing devices, cause the one or more computing devices to perform:
determining that the materialized view is eligible for logical partition change tracking-based query rewrite based on determining that an instantiation query of the materialized view references the logical partitioning key in a SELECT clause of the instantiation query and in a GROUP BY clause of the instantiation query.

15. The one or more non-transitory storage media of claim 11, further comprising instructions which, when executed by the one or more computing devices, cause the one or more computing devices to perform:
physically partitioning the database object into a plurality of physical partitions based on a physical partitioning key that is different than the logical partitioning key.

16. A computing system comprising:
one or more computing devices; and
instructions which, when executed by the one or more computing devices, cause the one or more computing devices to perform:
logically partitioning a database object into a plurality of logical partitions based on a logical partitioning key;
creating a materialized view that references the logically partitioned database object and the logical partitioning key;
maintaining a respective freshness state for each of the plurality of logical partitions based on tracking changes to records of the database object;
receiving a user query;
determining that the user query asks for data only from one or more fresh logical partitions, of the plurality of logical partitions, based on the respective freshness state for each of the one or more fresh logical partitions; and
rewriting the user query to retrieve data from a portion of the materialized view instantiated based on records of the one or more fresh logical partitions of the database object.

17. The computing system of claim 16, further comprising instructions which, when executed by the one or more computing devices, cause the one or more computing devices to perform:
before logically partitioning the database object, populating the database object with data; and
wherein the database object is logically partitioned while the database object comprises data.

18. The computing system of claim 16, further comprising instructions which, when executed by the one or more computing devices, cause the one or more computing devices to perform:
automatically logically partitioning the database object into the plurality of logical partitions as part of an autonomous database system operation.

19. The computing system of claim 16, further comprising instructions which, when executed by the one or more computing devices, cause the one or more computing devices to perform:
automatically creating the materialized view as part of an autonomous database system operation.

20. The computing system of claim 16, further comprising instructions which, when executed by the one or more computing devices, cause the one or more computing devices to perform:
logically partitioning the database object into the plurality of logical partitions based on receiving a command submitted to a database system by a user or a database application, the command specifying creation of the plurality of logical partitions and specifying the logical partitioning key.
